(19) United States
(12) Patent Application Publication
(10) Pub. No.: US 2014/0152911 A1
(43) Pub. Date: Jun. 5, 2014

(54) POINTING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHONG-HE YU, Shenzhen (CN); WEI-KUANG LIANG, New Taipei (TW); PENG ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/953,660

(22) Filed: Jul. 29, 2013

(30) Foreign Application Priority Data
Nov. 30, 2012 (CN) 2012105011291

(51) Int. Cl. G06F 1/16

(52) U.S. Cl. CPC G06F 1/169
USPC 349/12

(57) ABSTRACT

A pointing device includes a mounting panel and a touch panel. The mounting panel includes a panel body. The panel body defines an opening. The mounting panel further includes a bottom portion extending from an edge of the opening and a first positioning arm slanted and extending from the bottom portion. The touch panel is received in the opening and contacts the first positioning arm. The first positioning arm is pressed by the touch panel to be deformed when the touch panel is pressed down and rebounds to drive the touch panel to move back to an original position when the touch panel is free.

### BACKGROUND

1. Technical Field

The present disclosure relates to a pointing device for notebook computers.

2. Description of Related Art

Notebook computers include a pointing device, such as a touchpad. The pointing device includes an enclosure for mounting a touch panel. However, the touch panel cannot rebound when it is operated.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a pointing device.

FIG. 2 is similar to FIG. 1, but viewed from another aspect.

FIG. 3 is an assembled view of FIG. 2.

FIG. 4 is a cross-sectional view of FIG. 3 taken along a line IV-IV of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

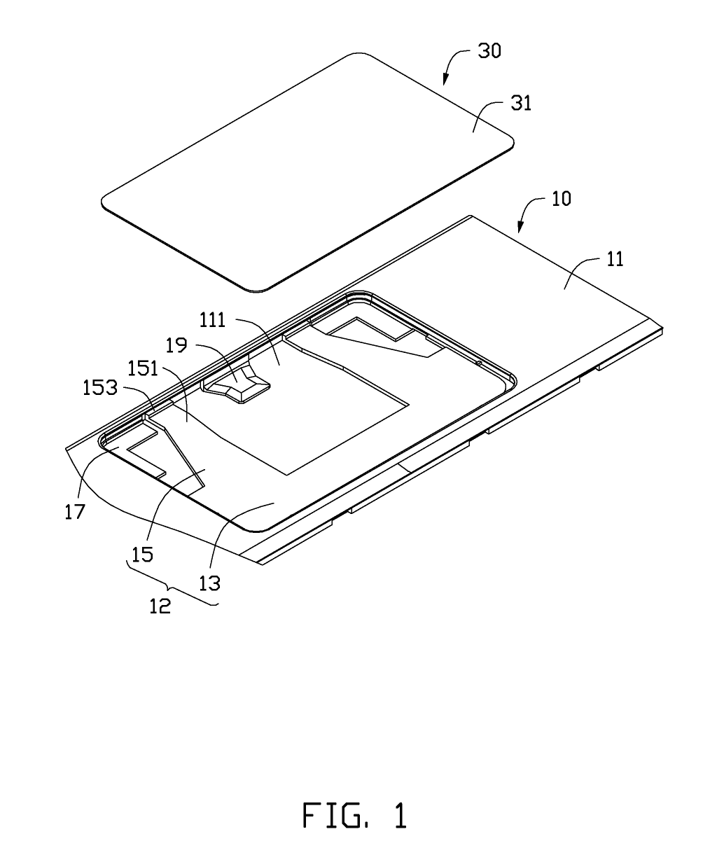

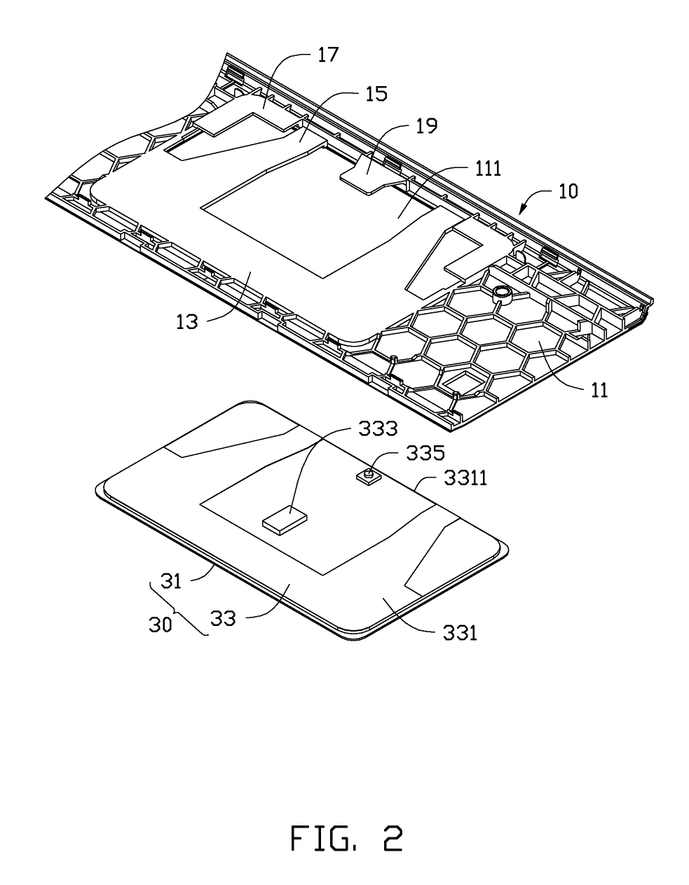

FIGS. 1 and 2 show a pointing device, according to one embodiment, including a mounting panel 10 and a touch panel 30.

The mounting panel 10 includes a panel body 11. The panel body 11 defines an opening 111 for receiving the touch panel 30. The mounting panel 10 further includes a positioning portion 12. The positioning portion 12 includes a bottom portion 13 extending from an edge of the opening 111 and two positioning arms 15 extending from the bottom portion 13. Each positioning arm 15 includes an arm body 151 and a positioning flange 153 extending from the arm body 151. The bottom portion 13 is substantially parallel to the touch panel 30. The arm body 151 is slanted and extends from the bottom portion 13. The mounting panel 10 further includes two resisting tabs 17 extending inward from two edges of the opening 111. Each resisting tab 17 is L-shaped and is substantially parallel to the touch panel 30. The two positioning arms 15 are located between the two resisting tabs 17. The mounting panel 10 further includes an associating tab 19 extending inward from an edge of the opening 111.

The touch panel 30 includes an outer panel 31 and an inner panel 33 mounted to the outer panel 31. The inner panel 33 includes a main body 331 attached to the outer panel 31, a connector 333 extending from the main body 331, and a sensor 335 extending from the main body 331. The cross section of the main body 331 is less than that of the outer panel 31 taken along a plane substantially parallel to the panel body 11. The main body 331 defines a side edge 3311 substantially perpendicular to the panel body 11.

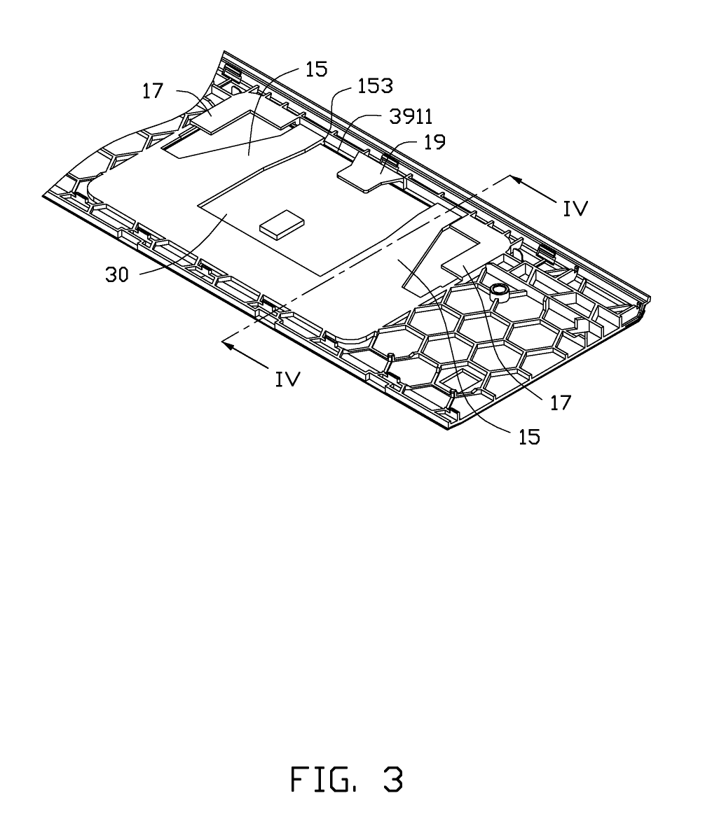

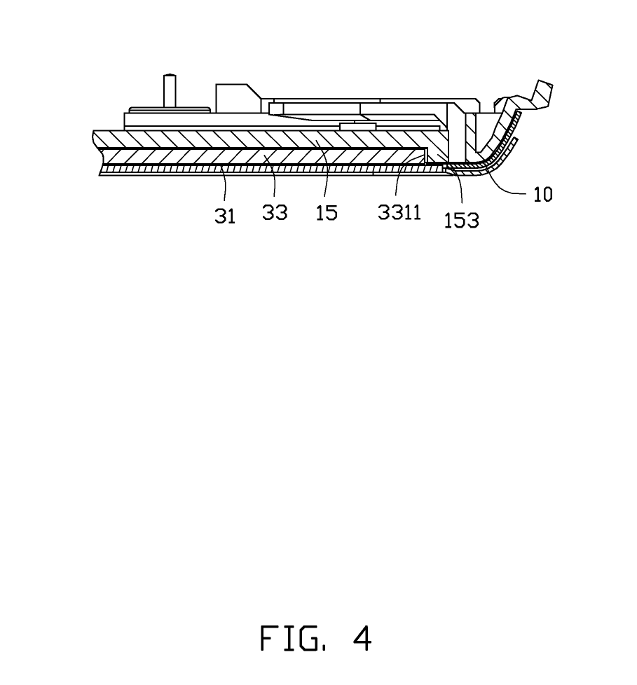

FIGS. 3 and 4 show that in assembly, the touch panel 30 is placed in the opening 111. The main body 331 of the touch panel 30 contacts the bottom portion 13 of the positioning portion 12. The positioning flanges 153 of the two positioning arms 15 resists the side edge 3311 of the main body 331 preventing the main body 331 from moving a direction substantially parallel to the panel body 11 and substantially perpendicular to the side edge 3311. The connector 333 of the touch panel 30 is placed between the two positioning arms 15. The sensor 335 corresponds to the associating tab 19. At this time, the outer panel 31 and the panel body 11 are on the same plane.

The touch panel 30 is pressed and the main body 331 moves down. The two positioning arms 15 are deformed. The two resisting tabs 17 resist the main body 331 when the main body 331 moves down to a position, thereby preventing the main body 331 from moving down. The associating tab 19 contacts the sensor 335 when the main body 331 is in the position. When the touch panel 30 is free, the two positioning arms 15 rebounds to enable the main body 331 to be in the original position.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A pointing device, comprising:
a mounting panel, the mounting panel comprises a panel body; the panel body defines an opening; and the mounting panel further comprises a bottom portion extending from a first edge of the opening and a first positioning arm slanted and extending from the bottom portion; and
a touch panel, the touch panel is received in the opening and contacts the first positioning arm;
wherein the first positioning arm is configured to be pressed by the touch panel to be deformed when the touch panel is pressed down and to rebound to drive the touch panel to move back to an original position when the touch panel is free.

2. The pointing device of claim 1, wherein the mounting panel further comprises a first resisting tab extending inward from a second edge of the opening, and the first resisting tab is configured to resist the touch panel when the touch panel moves down to a position.

3. The pointing device of claim 2, wherein the mounting panel further comprises a second resisting tab extending inward from a third edge of the opening; the first resisting tab and the second resisting tab are located on opposite side of the opening; and the first positioning arm is located between the first resisting tab and the second resisting tab.

4. The pointing device of claim 2, wherein the first resisting tab is substantially parallel to the panel body.

5. The pointing device of claim 4, wherein the first resisting tab is L-shaped.

6. The pointing device of claim 3, wherein the mounting panel further comprises a second positioning arm slanted and extending from the bottom portion, and the second positioning arm is located between the first resisting tab and the second resisting tab.

7. The pointing device of claim 1, wherein the first positioning arm comprises an arm body slanted and extending from the bottom portion and a positioning flange extending from the arm body; and the positioning flange resists the touch panel to prevent the touch panel from moving along a direction substantially parallel to the panel body.

8. The pointing device of claim 7, wherein the touch panel comprises an outer panel and an inner panel attached to the outer panel, and the inner panel is placed on the bottom portion to enable the outer panel to be in the same plane with the panel body.

9. The pointing device of claim 8, wherein the inner panel defines a side edge substantially perpendicular to the panel body, and the positioning flange resist the side edge to prevent the touch panel from moving a direction substantially parallel to the panel body and substantially perpendicular to the side edge.

10. The pointing device of claim 8, wherein the mounting panel further comprises an associating tab extending a second edge of the opening; the inner panel comprises a main body and a sensor mounted to the main body; and the sensor is configured to contact the associating tab when the touch panel is in the position.

11. A pointing device, comprising:
a mounting panel, the mounting panel comprises a panel body; the panel body defines an opening; and the mounting panel further comprises a bottom portion extending from a first edge of the opening and a first positioning arm slanted and extending from the bottom portion; and
a touch panel, the touch panel is received in the opening to be prevented from moving along a first direction substantially parallel to the panel body; and the touch panel contacts the first positioning arm;
wherein the touch panel is configured to be pressed, along a second direction substantially perpendicular to the panel body, to resist the first positioning arm be deformed, and the first positioning arm is configure to rebound to drive the touch panel to move back along a third direction substantially opposite to the second direction.

12. The pointing device of claim 11, wherein the mounting panel further comprises a first resisting tab extending inward from a second edge of the opening, and the first resisting tab is configured to resist the touch panel when the touch panel moves down to a position.

13. The pointing device of claim 12, wherein the mounting panel further comprises a second resisting tab extending inward from a third edge of the opening; the first resisting tab and the second resisting tab are located on opposite side of the opening; and the first positioning arm is located between the first resisting tab and the second resisting tab.

14. The pointing device of claim 12, wherein the first resisting tab is substantially parallel to the panel body.

15. The pointing device of claim 14, wherein the first resisting tab is L-shaped.

16. The pointing device of claim 13, wherein the mounting panel further comprises a second positioning arm slanted and extending from the bottom portion, and the second positioning arm is located between the first resisting tab and the second resisting tab.

17. The pointing device of claim 11, wherein the first positioning arm comprises an arm body slanted and extending from the bottom portion and a positioning flange extending from the arm body; and the positioning flange resists the touch panel to prevent the touch panel from moving along a direction substantially parallel to the panel body.

18. The pointing device of claim 17, wherein the touch panel comprises an outer panel and an inner panel attached to the outer panel, and the inner panel is placed on the bottom portion to enable the outer panel to be in the same plane with the panel body.

19. The pointing device of claim 18, wherein the inner panel defines a side edge substantially perpendicular to the panel body, and the positioning flange resist the side edge to prevent the touch panel from moving a direction substantially parallel to the panel body and substantially perpendicular to the side edge.

20. The pointing device of claim 18, wherein the mounting panel further comprises an associating tab extending a second edge of the opening; the inner panel comprises a main body and a sensor mounted to the main body; and the sensor is configured to contact the associating tab when the touch panel is in the position.
